(19) United States
(12) Patent Application Publication
(10) Pub. No.: US 2005/0019223 A1
(43) Pub. Date: Jan. 27, 2005

(54) Liquid delivery apparatus and method

(76) Inventors: Albert Edward Platt, Oxfordshire (GB); Robert Reid Townsend, St. Louis, MO (US)

Correspondence Address: KLAUBER & JACKSON, 411 HACKENSACK AVENUE, HACKENSACK, NJ, 07601, US

(21) Appl. No.: 10/496,760

(22) PCT Filed: Jul. 29, 2002
(86) PCT No.: PCT/GB02/03489

(30) Foreign Application Priority Data
Aug. 10, 2001 (FR) 0119565.0
Apr. 2, 2002 (GB) 0207531.5

(51) Int. Cl. B01L 3/02

(52) U.S. Cl. 422/100; 436/180

(57) ABSTRACT

Liquid delivery apparatus and methods, in particular for the production of high-density arrays, wherein a partial drop liquid is deposited from a capillary (1) onto a substrate (12), the capillary (1) and substrate (12) being capable of x, y and z movements relative to one another under the control of a translation mechanism.

This invention relates to liquid delivery apparatus and methods in particular for the production of arrays of spatially distinct sample spots. In particular the liquid delivery apparatus and methods of the invention enable the presentation of sample and matrix in small highly concentrated spots in an array format suitable for high throughput mass spectrometry analysis.

Recent advances in molecular genetics have revealed the benefits of high-throughput separation and analysis techniques and systematic strategies for studying the nucleic acids expressed in a given cell or tissue. These advances have highlighted the need for operator-independent computer-mediated methods for identifying and selecting subsets or individual molecules from complex mixtures of proteins, oligosaccharides and other biomolecules and isolating such selected biomolecules for further analysis.

Strategies for target-driven drug discovery and rational drug design require identifying key cellular components, such as proteins, that are causally related to disease processes and the use of such components as targets in therapeutic intervention. However, present methods of analyzing biomolecules such as proteins are time consuming and expensive and suffer from inefficiencies in particular during sample preparation for analysis.

Proteomics involves the systematic identification and characterization of proteins that are present in biological samples, including proteins that are glycosylated or exhibit other post-translational modifications and this approach offers great advantages for identifying proteins that are useful for diagnosis, prognosis, or monitoring responses to therapy and in identifying protein targets for the prevention and treatment of disease. Since one genome produces many proteomes (where proteome is the total protein complement of a cell or tissue) and the number of expressed genes in a cell is minimally 10,000, it is clear that characterization of the many thousands of proteins within these proteomes can only be accomplished using a high-throughput, automated process.

Currently, protein identification using proteomics separations can be divided into two main processes: 1) the separation and isolation of individual components within a sample of interest traditionally using 2D-electrophoresis (see U.S. Pat. Nos. 6,064,754 and 6,278,794) and more recently other chromatography methods in place of one or both dimensions of 2D-electrophoresis (Davies, H. et al., BioTechniques 1999, 27:1258-61; Senior, K. Mol. Med. Today 1999, 5:326-327; Wall, D. et al, Anal. Chem. 2000, 72:1099-111) and 2) the identification of these individual protein components. The enormous number of samples generated during 2D-electrophoresis or by other separation techniques places great demands on general protein characterization instrumentation and increasingly it is accepted that the only means of identification that is amenable to handling these enormous numbers and that is sufficiently sensitive enough to detect the extremely small quantities involved, is mass spectrometry. In particular, matrix-assisted laser desorption ionization (MALDI) which is ideally suited to time of flight (TOF) mass spectrometry provides the sample throughput and ease of automation necessary to identify thousands of individual proteins in an acceptable time frame. A range of mass spectrometers is suitable for this analysis (see PCT/GB01/04034; Yates, J. et al., 1993, Anal. Biochem. 214:397-408; Mann, M. et al., 1993, Biol. Mass Spectrom. 22:338-345).

However, an essential part of an industrial platform for proteomics is the ability to perform microdelivery of sample containing minimal amounts of material (e.g. in the amol and low fmol range) for MALDI mass spectrometric analysis. Preparation of samples for analysis using MALDI involves the drying of a mixture of sample and a matrix material on a target substrate resulting in a material mass of sample-doped matrix crystals. The efficiency of MALDI has been shown to be highly sensitive to the sample preparation procedure and it is generally accepted by those in the art that sample molecules must be distributed throughout the crystals rather than being confined to their surface for efficient ion production to take place and that to reach an efficient level of sample throughput, analysis time is of the utmost importance. Samples for high speed analysis must be presented in reproducibly small, highly concentrated homogeneous spots thus avoiding the rate limiting repetitive so called “sweet spot” searches on the crystal surface to obtain a stable high intensity ion signal with the mass spectrometer laser.

“Sweet spot” searches are a consequence of large spot sizes (Nordhoff, E. et al., 2001, Electrophoresis 22: 2844-2855) and inhomogeneous crystallization. Uneven crystal deposition, where some components are found in certain positions within the spot and not others, is a problem typically encountered using traditional methods of laying down spots where the spot diameter is large and sample dilution high (Scheurenberg, M. et al., 2000. Anal. Chem. 72: 3436-3442). Inhomogeneous crystallization slows down the data acquisition process as it forces the MALDI mass spectrometer user to search for “sweet spots” on the crystal surface and also affects sample-to-sample reproducibility of MALDI results. A large spot size also necessitates user intervention in monitoring the signal-to-noise ratio from the mass spectrometer and repositioning of the laser accordingly, in the search for a “sweet spot” (an area of high signal-to-noise ratio). Irreproducibility and poor correlation between signal and sample concentration typically occur in spots with a low abundance of sample and are compounded when in conjunction with a large spot size. Thus homogeneous and small spots that are also concentrated mean faster data acquisition in that fewer laser shots are needed to give the required result. Homogeneous, small and concentrated sample spots also mean increased sensitivity, better sample-to-sample reproducibility and better correlation between the signal and sample concentration.

A separation step is often necessary when analyzing a mixture of biomolecules in order to avoid ion suppression effects and hence lower sensitivities of detection (Beavis, R. and Chait, B. 1990. Proc. Natl. Acad. Sci. 87: 6873-6877; Zalulec, E. et al., 1995, Protein Express. Purif. 6: 109-123). Ion suppression effects are a particular problem associated with robotic technology (e.g. Cartesian Workstations, Cartesian Technologies, Inc., Irvine, Calif.; the Sybiot™ I Sample Workstation, Applied Biosystems, Foster City, Calif.; and the Bruker Daltonik MALDI Autoprep Robot System, Bruker Daltonik, Bremn, Germany) that permits the production of small spot sizes, because a small spot size gives not only sample enrichment but also enrichment of ion suppressing contaminants. Chromatographic separations, particularly high performance liquid chromatography (hplc) and capillary electrophoresis, have been used as a sample purification step for sample application as an array suitable for MALDI (Miliotis, T. et al., 2000, J. Mass Spectrom. 35: 369-377; Miliotis, T. et al., 2000, J. Chromatog. A 886: 99-110; Johnson, T. et al., 2001, Anal. Chem. 73:1670-1675). In particular, the output of the hplc chromatography step has been automatically delivered as an array of sample spots on a substrate suitable for MALDI mass spectrometry. However, the flow-through dispenser interfaced to a chromatography column in the reports by Miliotis et al. permits only a portion of the sample to be deposited, but enrichment is vital when analyzing unresolved samples such as those sometimes obtained from in-gel digested samples separated using two-dimensional electrophoresis where the amounts available for analysis can be extremely small.

There is also a need to control spot size with respect to the organic solvent content of the sample, for example when spotting samples eluted in increasing organic solvent from a hplc column. Additionally, automatic monitoring and feedback control over sample and matrix delivery and spot size is highly desirable and increasingly necessary to permit automated high throughput for analyses. The methods mentioned above also rely on the use of more expensive pre-structured sample supports that require pre-deposition of matrix and the inefficiencies associated with this as discussed below.

Although various means for producing high density arrays of small spots are known in the art, traditional methods of laying down spots involve pipetting or capillary feeds (e.g. a Probot™ Micro fraction collector, LC Packings) and produce spots approximately 1000-1500 μm in diameter, often resulting in the need for manual intervention in the search for the best ‘signal’ site during laser irradiation. Other delivery systems known in the art such as piezo-electric or inkjet valve devices can deliver the required small spot size but are unable to handle the small volumes, typically less than 1 μl, of pre-concentrated sample when used in an aspirate/dispense mode, or have a high internal volume resulting in sample dilution. Several examples of piezo-electric and capillary transfer devices can be found in U.S. Pat. Nos. 6,296,702, 6,110,426, 6,040,193 and 5,958,342; EP 1002570 and 1157737 and WO 01/76732. Recently, a flow through piezo-electric microdispenser has been developed where drops of liquid are ejected from within a flow cell perpendicular to a passing flow (Önnerfjord, P. et al., 1998, Anal. Chem. 70: 4755-4760). However, only a subfraction of the passing flow of liquid is ejected and hence samples of low concentration have a reduced chance of detection. Piezo-electric or inkjet valves have also proven unreliable in the delivery of matrix solutions that are used in MALDI mass spectrometry analysis due to crystallization (Önnerfjord, P. et al., 1998, Anal. Chem. 70: 4755-4760) and corrosion due to particular solvents used within the valve. Because of these problems automated methods known in the art typically rely on the use of substrates to which matrix has been pre-applied by spreading or spraying. Sample is then applied to the dried matrix. However, drying of matrix mixed with sample results in better spot homogeneity than if liquid matrix is added to a dried sample spot or liquid sample is added to a dried matrix spot (Önnerfjord, P. et al., 1998, Anal. Chem. 70: 4755-4760) and it is clear that better homogeneity equates to increased detection capability and faster data acquisition times.

Pin-tool devices that carry hardened steel printing pins with for example a sample channel at the tip that acts to hold and deposit a pre-determined volume of sample by multiple contacts with an array surface, are known in the art (see U.S. Pat. No. 6,101,946; Affymetrix 427™ Arrayer, Affymetrix, CA) but have several disadvantages. Accurate arrayment using this sort of device typically relies on the use of substrates comprising an array of hydrophilic anchors to correctly position sample during deposition but these generally require that substrates be pre-coated with matrix before sample deposition if MALDI analysis is to be performed. The sample channels in the printing pins hold a much larger volume than is actually deposited resulting in unnecessary wastage of what can often be a precious and limited quantity of sample. Additionally, the unreliability of new pins requires that thousands of preliminary test depositions be performed before a set of reliable pins can be selected (Thompson, A. et al., 2001, Trends in Microbiol. 9: 154-156). Pin-tools are also prone to blockage during repeated use.

The spots forming an array should ideally be applied as a well-defined high density array (e.g. of 1000 spots or more), accurate both in the spatial relationship of spots to each other and of the whole array on the target plate. The array should also be consistent between different target plates thus eliminating the need for constant re-programming of the laser search pattern when analyzing a series of target substrates. Liquid handling technologies using acoustic energy are available but necessitate the separate collection of multiple samples (Ellson, R. 2002, Drug Discovery Today 7: S32-S34).

Spot formation known in the art and that is amenable to high throughput processes generally uses either:
(1) a method commonly known as the dried-drop method where sample and matrix are mixed (Karas, M. and Hillenkamp, F. 1988, Anal Chem. 60: 2299-2301), or alternatively liquid sample is added to pre-deposited matrix or vice-versa, liquid matrix is added after sample deposition (Ekström, S. et al., 2000, 72: 286-293; Ekström, S. et al., 2001, Anal. Chem. 73: 214-219). However, the latter can provide a somewhat lower sensitivity of detection i.e. a lower ion signal (Ekström, S. et al., 2000, 72: 286-293). These methods are generally performed manually with dry spot formation taking up to several minutes drying time;
(2) a seed-layer method where sample spots are applied to a target plate which has been coated with a dilute solution of matrix followed by further application of matrix after drying of the sample spot (Onnerfjord, P. et al., 1999, Rapid Commun. Mass Spectrom. 13: 315-322) which is a relatively time consuming three step process; and
(3) pre-application of matrix, particularly alpha-cyano-4-hydroxycinnamic acid (CHCA), to the entire surface of a substrate using an air-brushing techniques or by spreading with a rod (Miliotis et al., 2000, J. Chromatog. A, 886: 99-110; Nordhoff et al., 2001, Proteomics 22: 2844-2855).

However, although peptides have an affinity for microcrystalline CHCA, for good performance of these crystals it is important that samples do not contain organic solvents, such as those used during LC separations, which may partially dissolve the matrix crystals (Gobom, J et al., 2001, Anal. Chem. 73: 434-438). Indeed, it is recommended that organic solvents are not used with substrates containing hydrophilic anchors because of wetting and hence spreading problems (see U.S. Pat. No. 6,287,872). The wide-spread use of pre-application of matrix on substrates brings with it inherent problems such as inconsistency in the thickness of the matrix layer upon the substrate resulting in sample-to-sample variability and plate-to-plate variability in the amount of matrix applied. It has been reported that some increase in sensitivity can be achieved using samples separated by two-dimensional gel electrophoresis when using pre-applied CHCA in particular by removing the sample before it has dried a short time after application; an inexact and time-consuming procedure which is not amenable to high throughput. This technique is also limited by the concentration of matrix which must be kept low and the choice of a suitable solvent lacking organic content in order to ensure crystallization occurs solely upon the hydrophilic sample anchors (Gobom, J. et al., 2001, Anal. Chem. 73: 434-438 and U.S. Pat. No. 6,287,872).

Pre-mixing of liquid sample and liquid matrix followed by automated delivery is problematic due to matrix crystallization within the types of valves available for use (as discussed above) and in these instances manual application of pre-mixed sample and matrix is typically performed. The method described herein bypasses these problems and enables the addition of liquid matrix to liquid sample in multiple permutations. In particular, the matrix formulae described infra can be delivered via an inkjet valve and use of any of these formulae is advantageous to maintaining reliability in such valves. It is also known in the art that discriminatory effects dependent upon factors such as peptide mass and solubility are observed upon MALDI analysis such that differential results can be observed when using different matrix formulations (Cohen, S. and Chait, B. 1996, Anal. Chem. 68: 31-37).

Despite recent advances none of the present liquid delivery methods meet all of the criteria that are necessary to allow the automated, high throughput, cost-effective and successful sample preparation and array production that is desirable in e.g. proteomics analysis.

The present invention provides liquid delivery apparatus and methods which enable the rapid, accurate and efficient production of concentrated sample spots on a substrate, e.g. as an array. The invention provides an effective interface between the two main areas of proteomics analysis namely, proteomics separations and protein identification using mass spectrometry, and permits the non-contact addition of liquid matrix to liquid sample giving efficient homogeneous crystallization. The invention also enables the control of spot size and position on a substrate irrespective of the presence or absence of specialized pre-formed structures on the substrate and irrespective of the organic solvent content of sample, sample enrichment and/or purification.

Accordingly, the invention provides a method for delivering a spot of liquid onto a substrate comprising:
(a) bringing a hollow capillary into contact with the liquid;
(b) locating the capillary above a selected position on the substrate;
(c) delivering a partial drop of liquid from the capillary onto the substrate by relative movement of the capillary and substrate;
(d) retraction of the capillary and substrate relative to each other; and
(e) repeating steps (c) and (d) one or more times.

In the method of the invention the partial drop of liquid is deposited on the substrate as it forms at the end of the capillary preferably before it can grow larger than the external diameter of the capillary. In a preferred embodiment, the partial drop of liquid is allowed to grow for a pre-set time prior to deposition upon the substrate. Alternatively, the size of the forming drop of liquid is continuously and accurately monitored using, for example an operably connected machine vision system such that when the drop has reached a pre-selected size it is deposited on the substrate. In this manner, a selected volume of liquid may be deposited upon the substrate in one or more applications. Steps c) and d) are preferably performed such that retraction of the capillary and substrate breaks the fluid contact between the substrate and the capillary i.e. such that a plurality of discrete partial drops of liquid are deposited onto the substrate to form a liquid spot. Alternatively the retraction of the capillary and substrate does not result in breakage of the fluid contact between the substrate and capillary, the relative movement of the capillary and substrate being adjusted until the required volume of liquid has been deposited on the substrate. Accordingly, the retraction of the capillary is such as to maintain the contact of the partial drop of liquid with both the capillary and the substrate, the relative movement of the capillary and substrate being controlled to maintain a column of liquid between the substrate and the capillary of a pre-determined width.

A capillary which is contactable with liquid is a capillary that can be filled with liquid, by for example direct or indirect connection to a liquid delivery system such as a pump. Preferably, the capillary is contacted with the flow of liquid issuing from the end of a sample separator (i.e. the eluant) by directly linking the capillary to said separator. A sample separator includes any device for separating at least partially, the individual components within a sample. Such devices include, but are not limited to, a high performance liquid chromatography (hplc) system or a capillary electrophoresis device. In another particular embodiment, the capillary of the liquid delivery apparatus can be used in an aspirate and dispense mode or in a flow mode where the chromatography column attached to the sample separator is bypassed (off-line). It is readily apparent that either of the above methods of sample application is applicable in these modes using controlled flow ejection from the capillary outlet of the liquid delivery apparatus.

The capillary may be made of any suitable material e.g. fused silica.

The end of the capillary from which the sample is delivered may be rendered liquid repellant, for example by coating it with a liquid repellant substance such as silicone. The growing drop of liquid is repelled from the liquid repellent external edge of the capillary enabling a drop of liquid that is smaller than the outer diameter of the capillary to grow and be deposited as required, resulting in a spot whose diameter is smaller than the outer diameter of the capillary. The liquid repellent surface of the capillary end is also effective in reducing movement of liquid up the outside of the capillary as occurs with increasing organic solvent concentration (decreasing surface tension) and, depending on the diameter of the capillary chosen, this enables very small drops to be deposited. It is further understood that a coating can be applied to any surface of the capillary.

The spot diameter of liquid deposited on the substrate can be readily altered by altering the capillary diameter. Spot diameters produced according to the apparatus and the method of the invention are, for example, less than about 750 μm and preferably between 100 μm and 500 μm and yet more preferably about 400 μm.

The capillary can be housed by any suitable means such as held in a clamp, inserted through a block of material that holds the capillary in the desired orientation or housed in a fixed position by a screw or any other suitable means. The capillary is preferably easily removed from and/or replaced in the housing. In one embodiment, multiple capillaries can be accommodated in the capillary housing.

The apparatus and methods of the invention can be used to deliver liquid onto any suitable substrate, e.g. a vessel, or more preferably a substantially planar surface. The invention is particular suited to the production of high density arrays on planar substrates. In a preferred embodiment, the substrate is compatible with MALDI mass spectrometry, and is preferably supplied with internal reference markers permitting alignment of the substrate within suitable analytical instrumentation.

The nature of the substrate holder will be determined by the substrate that is to be used. The substrate holder is preferably positioned so as to be moveable with the x, y axes of the translation mechanism.

The liquid delivery device of the invention comprises a translation mechanism capable of x, y, z movements, preferably a robotic translation mechanism. Such translation mechanisms are well known in the art and are commercially available for example from Jamac Inc., Elk Grove Village, Ill. The relative movements of the capillary and substrate can be achieved by moving the capillary and/or the substrate, thus for example the translation mechanism may enable the capillary to move in the x and z directions whilst the substrate is moved in the y direction. In one embodiment, the translation device can carry multiple capillaries and/or substrates.

In addition to carrying the substrate in a suitable holder and the capillary housing, the translation mechanism is preferably modified to carry at least one camera and/or machine vision system. The only constraint on the size of an array of sample spots delivered onto a substrate is the size of the substrate itself and/or the maximum travel permitted by the x, y, z translation mechanism selected. The translation mechanism preferably allows spots to be accurately placed to within a few μm of each other on the substrate to form an array. It is apparent that the z movement that regulates the distance between the capillary and the substrate may be increased or decreased by movement of substrate with respect to the capillary and not only by movement of the capillary with respect to the substrate.

The relative movement of the capillary and substrate is preferably adjusted such that the capillary does not come into physical contact with the substrate on deposition of the partial drop of liquid, however the apparatus may be used in a manner where the capillary does contact the substrate.

Control of deposition of liquid upon the substrate is preferably achieved using a pre-set time. In this embodiment a pre-selected volume of liquid can be deposited in a plurality applications upon the substrate. The number of applications required to deposit the desired volume can be determined using several considerations such as the flow rate of the liquid from the capillary, the solvent content of the liquid and the diameter of the spot required. Hence, the pre-set time and number of applications of liquid onto the substrate can be varied to accommodate the flow rate of the liquid from the capillary. The apparatus of the invention enables the liquid to be deposited whilst it is at the partial drop stage thus controlling the size of the resulting spot of liquid on the substrate. Thus, small highly concentrated spots of sample are produced.

Alternatively, a micro-flow rate detector can be installed in the capillary line to deliver a signal to commence spotting at a pre-set time.

In another preferred embodiment, control of deposition of liquid upon the substrate is achieved by continuously monitoring and detecting the formation of the forming drop of liquid from the capillary. This control is preferably achieved using a machine vision system. Machine vision systems are well known in the art and include image processing systems comprising a camera and video system and software for performing an engineering task such as, for example a Simatic machine vision system available from Siemens, UK or a machine machine vision system from Omron (Tokyo, Japan). The machine vision system is operably connected to the translation mechanism permitting active control of the liquid delivery apparatus. The term operably connected includes for example, a direct link (e.g. a permanent or intermittent connection via a conducting cable, an infra-red communicating device, or the like) or an indirect link whereby instructions are transferred via an intermediate storage device (e.g. a server or a floppy disc).

More preferably, the apparatus of the invention comprises two detection systems, e.g. two machine vision systems, one for control of the deposition of liquid and the other for quality control purposes. For example but without limitation, the apparatus can comprise an observational camera such as without limitation, a video camera system permitting close observation of the device to aid in setting up the relative positions of the substrate and capillary, the observation of the condition of the capillary and the observation of the deposition of sample and matrix; and a machine vision system that is operably connected to the delivery device permitting active control of the liquid delivery device.

The machine vision system preferably allows the apparatus to deliver a measurable volume of liquid continuously to produce a concentrated drop of sample on a substrate. The machine vision system is operably connected to the liquid delivery apparatus of the invention and permits automatic accommodation of the flow rate from the capillary by adjustment of the number of depositions and/or the evaporation rate of the liquid, as well as supplying flexibility in the geometry of the array. Monitoring can be performed at the spotting position by adapting the machine vision system to travel in conjunction with the translation mechanism. In one embodiment, the machine vision system is attached to the translation mechanism permitting movement along the x and z axes, and controls and/or monitors the deposition of liquid upon the substrate. Alternatively, the machine vision system can be located such that it is transported along one axis, or along all three axes. Control and detection of delivery is achieved using the ability of a machine vision system to detect boundaries using surface edge techniques known in the art permitting the user of the apparatus to ascertain if sample has been delivered onto the substrate and to, for example, instruct the capillary to descend and deliver another partial drop of liquid or to move on to another position. Spot size can be controlled using the machine vision system using boundary markers in a defined area relating to the size of the spot required. For example, the machine vision system can detect the formation of a partial drop of a defined size from a capillary using boundary markers i.e. edges. When such an edge is reached, a difference in the boundary definition is registered by the machine vision system. Using standard control functions and software known in the art and available for use with machine vision systems, the capillary is then instructed to descend to contact the partial drop of liquid onto the substrate and then to retract, resulting in delivery of a partial drop of liquid onto said substrate. Detection of delivery can also be monitored using a machine vision system i.e. quality control. In one embodiment, the machine vision system may be held in a fixed position. Alternative means of spot deposition detection are known in the art, for example but without limitation, droplet impact detection or stroboscopic illumination such as disclosed by Allmaier, G. 1997, Rapid Comm. Mass Spec. 11:1567-1569.

In another embodiment, spots of liquid are formed and continuously monitored using a machine vision system, by generating a partially formed drop at the outlet of the capillary, bringing together the capillary outlet and the substrate until the growing drop contacts the substrate, and maintaining this contact whilst retracting the capillary, thus forming an diabolo-shaped (or hour-glass) column of liquid. Control of this technique is via surface edge techniques as described above. The machine vision system enables automatic adjustment of the distance between the capillary and the substrate thus accommodating the flow rate of the delivery apparatus, until the required volume of liquid and spot diameter on the substrate is achieved.

Each spot is accurately delivered and accurately positioned with the selected distance between spots (the pitch) preferably varying by only a few μm. Spots forming an array are preferably delivered with an accuracy of plus or minus 10 μm making efficient automated sample analysis possible.

Preferably the liquid delivery apparatus is enclosed, for example within a cabinet, preferably provided with a lighting source.

The liquid delivery method of the invention preferably comprises delivery of a second liquid apparatus from for example but without limitation, one or more thermal, electrical or mechanical liquid delivery devices such as, piezo-electric or ink-jet valves, such devices being adopted for the delivery of a second liquid, for example a matrix formulation onto the substrate e.g. into the drop of liquid deposited on the substrate by the capillary. Accordingly, the invention also provides a liquid delivery apparatus comprising:
(a) at least one hollow capillary contactable with the liquid;
(b) a housing to retain said capillary in a desired orientation;
(c) one or more thermal, mechanical or electrical second liquid delivery devices;
(d) a housing to retain said second liquid delivery device in a desired orientation;
(d) a substrate holder; and
(e) a translation mechanism capable of performing x, y and z movements, said mechanism being capable of moving said capillary, second liquid delivery device and substrate holder relative to one another.

Matrix formulations include chemical compounds used for MALDI MS with the required properties of (1) having a strong absorbance at the laser wavelength and (2) being of low enough mass to be sublimable. Suitable matrices are well known in the art as are solvents suitable for dissolving matrices. These include but are not limited to alcohols such as ethanol and propanol, acetonitrile and acetone. A low concentration of biomolecules within a sample is advantageous in that it increases the efficiency of energy transfer from the laser to the biomolecules (via matrix), problems associated with dissociation are greatly reduced, association of biomolecules to form high-mass clusters is also reduced and suitable matrices may even enhance ion formation because a low concentration of biomolecules is uniformly dispersed throughout the solid or liquid matrix. The biomolecules are distributed throughout the matrix so that they are completely isolated from one another, this is necessary if the matrix is to form a homogenous ‘solid solution’ (any liquid solvents used in preparation of the ‘solid solution’ are removed when the mixture is dried before analysis).

Most preferably, an ink-jet valve is used to deliver the second liquid, e.g. matrix, into a liquid sample spot present on a suitable substrate. The matrix valve can be modified by machining the end of the valve back to bring the valve orifice as close to the sample spot laid down on the substrate as possible. Preferably, the matrix valve is located in a housing adjacent to the capillary housing and is preferably easily removed and replaced in the housing with a new or a different valve. It will be apparent that the second liquid delivery system can alternatively be located in the same housing as the capillary. More preferably, the matrix valve is brought to a position close to the substrate ensuring accurate delivery of matrix to liquid sample with minimal disturbance to the liquid sample spot. In one embodiment, the matrix valve delivers matrix from approximately 0.5 cm away from the sample spot giving a high degree of accuracy, but matrix can be fired from the valve from a shorter or a greater distance, e.g. up to 2.5 cm away. In another embodiment, different compositions of liquid matrix material are added to replicate samples using separate ink-jet valves allowing the collection of differential MALDI MS sequence information. Preferably, a high density array (for example, but without limitation, about 1000 spots) of a material mass, of the type suitable for MALDI mass spectrometry is generated by evaporation from a liquid sample to which a liquid matrix material has been delivered. A material mass refers to that mass remaining after drying of a mixture of a liquid matrix material suitable for mass spectrometry and for example but without limitation, a liquid sample of peptides. Drying of this mixture deposited using the device and method of the present invention results in a uniform distribution of the functional crystals formed by the co-crystallisation of sample and matrix.

Matrix solutions may be prone to crystallising in the delivery valve. Therefore, the matrix valve is preferably capped when not in use to prevent drying of the liquid within, thus preventing the formation of crystal deposits that could block the orifice of the valve or cause deflection of the stream of droplets fired from the valve. Deflection of the droplets could result in the matrix material being inaccurately placed or result in the matrix missing the sample spot altogether. In addition, the delivery orifice of the valve is preferably washed and dried regularly during the liquid delivery operating cycle. This routine enables the use of inkjet valves (thermal, mechanical or electrical) reliably and is important to the maintenance of an automated and hence high-throughput system.

Preferably, the surface edge technique of a machine vision system is used to detect the deposition of matrix for example, by comparing two different ‘scenes’; the first being a view of a defined area where no matrix has been deposited and the second being a view of that same area where matrix has been deposited. A difference in the boundary definition of the defined area between these two scenes indicates that matrix has been deposited. If no difference exists the machine vision system can instruct the delivery apparatus to deliver matrix to the appropriate spot or alternatively to trigger an alarm for a user to respond to.

Alternatively, matrix can be delivered pre-mixed with the sample, for example by using a splitting device allowing on-line mixing of matrix and sample. The splitter can be located where desired, for example and without limitation, within the capillary feed or the capillary.

In another embodiment, a means of controlling the drying rate of the deposited drop of liquid is provided by, for example, controlling the temperature of the substrate or the surrounding atmosphere within a cabinet. Most preferably, the temperature is controlled using a proportional integral derivative (PID) system permitting tight temperature control and hence constant drying times of liquid sample deposited on a substrate. Such devices are well known in the art. Alternatively, any other means of controlling the temperature and drying times of liquid sample spots can be used such as, without limitation, an air-flow directed towards the substrate. In one embodiment, control of drying rate can be achieved by applying a localized heat source.

Most preferably, the invention also provides an integrated computer program that directs a liquid delivery apparatus to perform the method of the invention. The computer program may also direct the apparatus to perform additional tasks, such as, for example, to commence or cease sample delivery to the substrate or to implement a wash cycle or to send liquid to waste. In a preferred embodiment, the liquid delivery apparatus is programmed to intermittently wash and dry the second liquid delivery system, e.g. the matrix valve, to ensure reliability and to wash the capillary as required for example but not limited to, between different sample separations thus ensuring that there is no cross-contamination between samples.

In the method of the invention, the formation of a sample spot on the substrate is achieved by repeated application of a partial drop of liquid to the same position on the substrate, e.g. by the application of a plurality of discrete partial drops of liquid. In this mode delivery of the liquid is achieved by relative movement of the capillary towards the substrate, deposition of a partial drop of liquid sample followed by retraction of the capillary, the deposition of a partial drop of liquid and retraction of the capillary being repeated one or more times. In another preferred embodiment, the retraction of the capillary relative to the substrate is greater after each deposition dependent on the height of the sample spot on the substrate. The delivery and application of liquid is achieved via movement of the substrate towards and away from the capillary again preferably with the application of sample and retraction of the substrate being repeated one or more times as above. It is also apparent that both the capillary and substrate can be moved towards and away from each other in concert or otherwise. The applied liquid is allowed to reduce in volume by evaporation, assisted or otherwise, between each repetition. Most preferably, matrix is applied via an ink-jet valve after the spot has reduced in volume but before it has dried. Most preferably, the drying rate is controlled for example using a PID system.

It is also apparent that retraction of the capillary relative to the substrate can be such that contact between the liquid issuing from the end of the capillary and the substrate can be maintained such that a diabolo-shaped (or hour-glass) column of liquid is formed. In this embodiment, the retraction of the capillary and the substrate with relative to each other is automatically adjusted preferably using a machine vision system, and is dependent on the flow-rate of the liquid from the capillary and the drying rate of the liquid forming the diabolo shape.

Preferably, the liquid delivery device of the invention can be programmed to deliver a set volume of liquid in a variable number of deliveries as required. Thus, for example, the solvent content of a chromatography eluant can be accommodated, by increasing the number of depositions performed by the apparatus per spot. In one embodiment, each spot may be deposited using a different number of depositions or alternatively, batches of spots can be delivered with a certain number of depositions whilst the next batch can be delivered in a greater or lesser number of depositions.

Non-contact delivery of liquid matrix to liquid sample is enabled preferably using an inkjet valve. In a preferred embodiment, the delivery of one or more aliquots of matrix is delayed until the sample spot is substantially reduced in size by controlled or assisted evaporation but is still in liquid form. This enables the optimum concentration of matrix to be added at the time required for optimal crystal formation. In a preferred embodiment, the size of the spot is optically monitored using an operably connected machine vision system and surface edge technology used to signal the liquid delivery valve to deliver matrix when the spot has reached a pre-determined size. Addition of liquid matrix to each small spot of highly concentrated, evaporating sample gives matrix/peptide crystals that are both functional and uniformly deposited over the area of the spot. Further pre-determined deliveries of matrix can be added whilst the sample spot is still liquid but, preferably, after it has been reduced in size by evaporation, controlled or assisted. Non-contact deposition of liquid matrix via an inkjet valve to an evaporating, but still liquid, sample gives the added flexibility of using a higher matrix concentration as required by adding further volumes of matrix solution to the sample spot whilst allowing further evaporation to occur. This mode of addition of matrix is independent of parameters such as the flow rate from the capillary of the liquid delivery apparatus and temperature. A second ink-jet type valve can be deployed to add a different matrix formulation to replicate sample spots giving additional sequence information, thus giving the opportunity of obtaining a more complete coverage of components in a sample.

In another embodiment, matrix is pre-applied to the substrate followed by delivery of sample. Further pre-determined deliveries of matrix can be added whilst the sample spot is still liquid. It is apparent that any combination of matrix and sample application and number of applications of sample and/or matrix may be employed including, but not limited to, adding matrix first followed by sample, adding sample first followed by matrix and adding sample first followed by matrix and further addition(s) of matrix and vice-versa. Alternatively, the matrix can, if required, be added to the sample after it has dried, or a grid of matrix spots can be applied to the substrate before the sample is added.

The method of the invention permits the flexibility of using different matrix formulations for the same or different spots on a substrate in an automated manner thus giving the opportunity of obtaining a more complete coverage of components in a sample.

As mentioned previously the invention can be applied to the deposition of liquid spots onto any suitable substrate. The invention enables the production of small, e.g. less than 400 μm in diameter, accurately placed and highly concentrated spots on substrates without pre-structured supports, for example polished stainless steel, where previously, spots of 1 mm diameter or more would result without the use of specialised plates (see U.S. Pat. No. 6,287,872). Polished stainless steel substrates are suitable for use in mass spectrometric analysis, they are extremely robust, re-useable and cost-effective. Such substrates are preferably uniquely marked by, for example but not by way of limitation, etching or jig-drilling with at least three alignment features. These features permit alignment against an operator-defined point (this is the same defined point on each substrate) and means that re-calibration of the spot location coordinates within the mass spectrometer is not required on loading of a new substrate from, for example but without limitation, a cassette. Thus fully automatic, user-independent operation is enabled. The method and liquid delivery apparatus of the invention also permit the avoidance of time-consuming pre-coating of plates with matrix material. Hence, the device and methods of the invention represent a substantial advance in the development of a highly accurate means of producing high density arrays of reproducibly accurately-delivered sample spots which are homogeneous and concentrated, in particular for MALDI mass spectrometry analysis.

Alternative substrates that aid exclusive sample deposition during solvent evaporation and direct matrix crystallization onto the sample drop are known in the art and are also applicable to the apparatus and methods described herein. These include pre-formed wells and the use of substrates with localized hydrophilic areas or hydrophilic anchors within a hydrophobic surface (Scheurenberg, M et al., 2000, Anal. Chem. 72: 3436-3442; Van Ausdell, D. et al., 1998, Anal. Biochem. 256: 220-228; Laurell, T. et al., 2001, J. Chromatogr. B Biomed. Sci. Appl. 752: 217-32; (Jespersen, S. et al., 1994 J. Rapid Commun. Mass Spectrom. 8: 581-584; Ekström, S. et al., 2001 Anal. Chem. 73: 214-219). An alternative cost-effective, robust and novel method of producing hydrophilic anchors is described below.

It has been found that modification of a normally relatively hydrophobic, polished metal surface by texturing renders that surface less hydrophobic. Additionally it was found, contrary to expectation, that a coarse texture gave the greatest reduction in hydrophobicity.

Accordingly, the invention provides a method for producing a substrate containing an array of coarsely textured spots for use as hydrophilic sample anchors comprising:
(i) applying a physical mask, for example but without limitation, a stainless steel substrate leaving the spot positions exposed. This mask can be a film of pre-perforated material or a coating produced by photolithographic methods;
(ii) shot blasting the masked substrate using a suitable abrasive medium such as but without limitation, glass drops, or etching the masked substrate with a suitable etchant; and
(iii) removing the mask and cleaning the substrate to remove loose material.

The surface texture obtained is a function of the type of abrasive medium, the blast pressure and the blast duration. Using a fixed pressure and a minimum experimentally determined time, a consistent texture is obtained. Thus the invention also provides a method of preparing a substrate having an array of hydrophilic sample anchors, each of which has been made more hydrophilic than the surface immediately surrounding the anchor, comprising:
(i) providing an electrically conductive substrate with a substantially planar surface;
(ii) applying a removable mask which leaves exposed areas of the substarte corresponding to spot positions;
(iii) rendering the exposed areas of the substrate more hydrophilic than the areas covered by the mask; and
(iv) removing the mask.

The liquid delivery apparatus and methods of the invention provide a number of advantages. They allow the automatic production of an array of spots containing the sample of interest and matrix, the latter being added to the continuously evaporating, pre-delivered eluant from a capillary outlet preferably connected to a hplc system. The production of reproducibly small spots which contain homogeneous, highly concentrated sample/matrix crystals ensures higher signal intensity-to-noise ratios over most of the area of the spot i.e. signal amplification, which in turn means an increased chance of assigning a peptide mass or sequence identity by means known in the art (see WO 02/21139).

The liquid delivery apparatus of the invention can be used in any application that requires accurate, low volume delivery of liquid onto a substrate e.g. a vessel or a substantially planar surface. In a preferred embodiment, the liquid delivery apparatus of the invention is used for the production of arrays for the analysis of peptides produced during proteomics analysis, for example the proteomics analysis of clinical samples.

Thus, according to the invention there is provided a method for producing an array of peptides for mass spectrometric analysis on a solid substrate comprising:
(a) bringing a hollow capillary into contact with a liquid sample containing polypeptides;
(b) locating the capillary above a selected position on the substrate;
(c) delivering a partial drop of liquid from the capillary onto the substrate by relative movement of the capillary and substrate;
(d) retraction of the capillary and substrate relative to each other;
(e) repeating steps (c) and (d) one or more times;
(f) relocating the capillary above a different selected position on the substrate and performing steps (c) to (e);
(g) repeating step (f) one or more times; and
(h) applying a matrix solution to the spots of liquid on the substrate before the liquid has completely evaporated.

In another embodiment, the liquid delivery apparatus of the invention Is used for the production of arrays for the analysis of, for example, single nucleotide polymorphism (SNP) detection, characterization of cDNA expression libraries and determination of short oligonucleotide sequences. Proteomics analysis using the high density arrays produced according to the invention can be used to determine the physiological or biochemical state of a body fluid, a tissue or a cell. The physiological or biochemical state refers to the condition of a cell or tissue after it subjected to a stimulus or is contacted with a molecule, such as a drug, hormone, or other ligand that stimulates or effects cellular activity, after the cell or tissue is partially or completely transformed to become for example, but not limited to, hyperplastic, cancerous, or metastatic, where the cell has entered an apoptotic or other pathway, whether the cell is dysfunctional or diseased, and the type of the cell, i.e. the tissue from which the cell is derived. All of this information is available from the proteomics analysis. Proteomics separations can be used to determine the protein complement of body fluids or exudates. Proteomics separations refers to any method of sample preparation for proteomics analysis, for example but without limitation, subcellular fractionation, 2D-electrophoresis and chromatography techniques known in the art including reversed phase chromatography. It also includes sample preparation for proteolytic digestion, by methods known in the art, and also samples digested by enzymatic or chemical means. In particular, samples separated using any liquid chromatography methods the production of eluant or effluent from which can be interfaced with the liquid delivery device of the invention by connection to the capillary feed of the device (see FIGS. 1 and 3).

In a preferred embodiment, protein-containing samples for delivery and application to substrate will have been subjected to differential labelling with stable isotopes before separation using a sample separation system, to allow relative quantitation of individual proteins by mass spectrometry. Preferably, a hplc system is used and is operably connected to the liquid delivery apparatus. The outlet of the chromatography column attached to the hplc device is connected to the feed capillary of the liquid delivery device. After differential labelling samples are combined and separated as discussed below. These techniques are ideally suited to the comparison of samples for example but without limitation, diseased versus normal tissue. By this means, proteins or peptides that are differently expressed in a disease state as compared to a non-diseased state can be detected in a biological sample and noted as a marker of the disease or change in biochemical status of the cell tissue or biological fluid.

The liquid delivery apparatus and method of the invention permit the automatic and reliable deposition of all the effluent from chromatographic separations as a well-defined array which has previously not been possible using presently available technology resulting in the substantial enrichment necessary for the detection of low levels of peptides. Alternatively, a splitter device can be employed to send a portion of the sample to a collection or waste station. Samples can also be prepared using traditional proteomics separations prior to spotting in an array format.

Most preferably, the samples to be analysed will comprise biomolecules differentially labelled with isotope-coded affinity reagents (ICAT) reagents (Gygi et al, Nature Biotechnology 1999, 17:994-999). This method relies on the use of ICAT reagent that is either in a “heavy form”, i.e., deuterated (D₈), or in a “light form”, i.e., undeuterated. The reagents are attached to proteins through the sulfhydryl groups of cysteine residues. Typically one biological sample is derivatized with the isotopically light ICAT reagent and another one with the heavy reagent. The mass spectrum will contain isotope pairs separated by mass to charge ratio of 8 for a charge state of 1, or 4 for charge state of 2. Relative quantification is determined by the intensity ratio of the peptide pairs. The differently labeled samples are combined, subjected to proteolysis and chromatographic separations such as hplc followed by, for example but without limitation, MALDI mass spectrometry (e.g. MALDI-TOF). The peptide sequence is obtained using MS/MS, for example but without limitation, using a TOF/TOF MS (see PCT/GB01/04034; Yates et al., 1993, Anal. Biochem. 214:397-408; Mann et al., 1993, Biol. Mass Spectrom. 22:338-345; Gygi et al., Nature Biotechnology 1999, 17:994-999) and is database searched to reveal the identity of the parent protein.

In a preferred embodiment, samples differentially labeled with ICAT reagents are separated using hplc and the hplc column output is interfaced to the capillary of the liquid delivery apparatus of the invention for automated arraying onto a substrate.

In another preferred embodiment, samples are differentially labelled and analysed by solid-phase isotope tagging and mass spectrometry using undeuterated (D₀) or deuterated (D₇) isotope tags (Zhou, H. et al., Nature Biotech. 2002, 19:512-515). Alternatively, peptides generated by digestion of samples are differentially labelled, or optionally fractionated prior to differential labelling with D₀- or D₃-methanol (Goodlett et al., 2001 Rapid Comm. Mass Spectrom. 15:1214-1221), or differential labelling of undigested sample using phosphoprotein isotope-coded affinity tag reagents (PhIAT) that combine stable isotope and biotin labelling to enrich and quantitatively measure differences in the O-phosphorylation state of proteins (Goshe, M. et al., 2001, Anal. Chem. 73: 2578-2586) or other stable isotopes followed by separation using hplc where the hplc column output is interfaced to the capillary of the liquid delivery apparatus of the invention for automated arraying onto a substrate. Matrix is preferably added as described above.

In an alternative embodiment, samples may be unlabelled or labelled, for example but not by way of limitation, with a radioisotope such as radioactive inorganic phosphate or metabolically labelled with S³⁵-methionine prior to separation using a sample separation system and application to a substrate.

The recent development of array-based “peptidomics” provides another approach to proteomics analysis with a requirement for the production of accurate high density arrays of concentrated sample spots and high throughput analysis, for example using MALDI mass spectrometry, which is met by the liquid delivery apparatus and methods described herein. Peptidomics refers to a recent development in proteomics analysis and comprises a robust, standardized system for detecting and quantifying the total amount of a particular biomolecule present using for example, analysis using mass spectrometry (see WO 02/25287).

It is also apparent to one skilled in the art that samples prepared using other methods of proteomics separations can be applied to a substrate by the liquid delivery device of the invention. They can also automatically be concentrated, desalted or further purified using an operably connected sample separation system before application onto a substrate using the liquid delivery apparatus. The use of chromatography permits the preparation of samples with no parallel enrichment of contaminants and hence substantial increases in the sensitivity of mass spectrometric detection.

In yet another embodiment, the sample separation system can comprise multiple separation columns permitting continuous delivery and application onto substrates. The sample separation system is preferably operably connected to the liquid delivery apparatus of the invention.

The invention provides the means for producing a high density array of accurately delivered and positioned concentrated sample spots suitable for rapid, high throughput, cost effective proteomics analysis in particular using MALDI mass spectrometry, and is implemented as an interface between the proteomics sample separations and identification processes.

The accuracy of the liquid delivery method enables the production of a well-defined high density array which is exact in pitch of spots and in placement of the array on the substrate with respect to internal reference points present on the substrate (see FIG. 7). This accuracy permits automatic loading of the substrates from, for example, a cassette into the mass spectrometer without the need for reprogramming the mass spectrometer substrate and spot location search pattern. More preferably alignment features on the substrate permit a computer to reliably distinguish between spots and hence sample identities. Even more preferably still, substrates may be archived for reanalysis at a later date without having to reprogram the mass spectrometer substrate and spot location search pattern. Preferably, spots of the array are delivered with an accuracy of plus or minus 10 μm making efficient automated sample analysis possible. Substrates prepared using the liquid delivery apparatus of the invention contain an extremely accurately placed array suitable for use, without limitation, with MALDI-interfaced techniques and permitting automatic loading of a substrate from, for example but without limitation, a cassette, and target spot alignment within for example but without limitation, MALDI mass spectrometers such as MALDI-TOF-TOF, MALDI Q-STAR and MALDI II Q-TOF. This facilitates extremely accurate location using the x, y-coordinates of any spot on a substrate within said mass spectrometer. This in turn enables accurate focusing of the laser shot onto any desired sample spot interactively or automatically using operator-specified x, y-coordinates downloaded from an operably connected data storage device.

In yet a further embodiment, the program also implements a laboratory information management system (LIMS) that tracks laboratory samples and associated data such as clinical data, operations performed on the samples, and data generated by the analysis of the samples.

In one embodiment, the accuracy of array placement and spot location upon the substrate and the accuracy of laser irradiation within a spot is such that reanalysis of the same spot at a later date is permitted. This accurate focusing also applies to multiple spots of identical samples that are reliably and accurately located. Preferably, this is via a computer program that implements a data tracking and management system such as, but not limited to, LIMS that tracks laboratory samples and associated data such as clinical data, operations performed on the samples, and data generated by the analysis of the samples. Preferably, relevant clinical information useful to the analysis is also catalogued and indexed to the corresponding sample using the LIMS. Such information preferably includes patient data such as family history, clinical diagnosis, gender, age, nationality, place of residence, place of employment, and medical history. Information related to the sample itself is also preferably indexed in the LIMS; such information can include, without limitation, the sample type, the precise location from which the sample was taken, the day and time that the sample was taken, the time between collection and storage, the method of storage, and the procedure used to obtain the sample.

Methods of indexing the information record to the proper sample can include the assignment of matching numbers to the record and the sample. This process is preferably automated through the use of barcodes and a barcode scanner. As each array is processed, the scanner is used to record the associated identification number into the LIMS, which tracks the sample through its various manipulations, thus preserving the link between record and sample. The use of barcodes also permits automated archiving and retrieval of stored samples.

All publications, including, but not limited to, patents and patent applications, cited in this specification, are herein incorporated by reference as if each individual publication were specifically and individually indicated to be incorporated by reference herein as though fully set forth.

### BRIEF DESCRIPTION OF THE FIGURES

FIG. 1 shows an enlarged front view of a capillary housing for deposition of sample onto a target substrate according to the invention.

FIG. 2 shows a side view of a liquid delivery device according to the invention with a camera.

FIG. 3 shows a front view of the liquid delivery device of the invention with the camera omitted for clarity.

FIG. 4 shows a view from the top of the delivery device giving a capillary head working view.

FIG. 5 is a sequence of scenes from a machine vision system showing drop formation and a discontinuous method of sample application onto a substrate using the method of the invention demonstrating the use of defined boundary markers.

FIG. 6 is a scene from an optical control device of drop formation and a second method of application using continuous contact with a substrate.

FIG. 7 is a representation of a polished stainless substrate showing the layout of 400 μm spots. Alignment features for the accurate placement of the whole array and individual sample spots upon the substrate are shown.

FIG. 8 shows eight MALDI spectra collected from eight consecutive spots on a polished stainless steel substrate produced using the apparatus of FIGS. 1 to 4. The intensity of ions is indicated as a percentage of the most intense ion which is set at 100%.

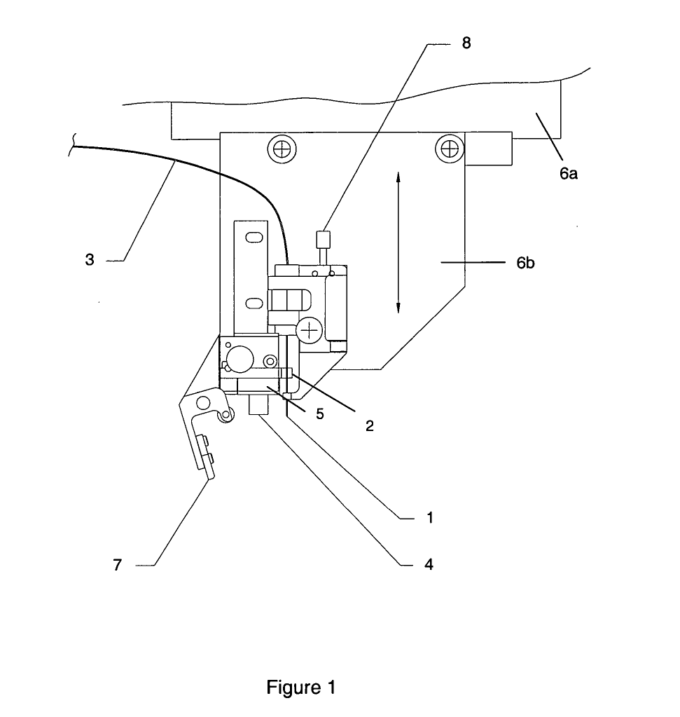

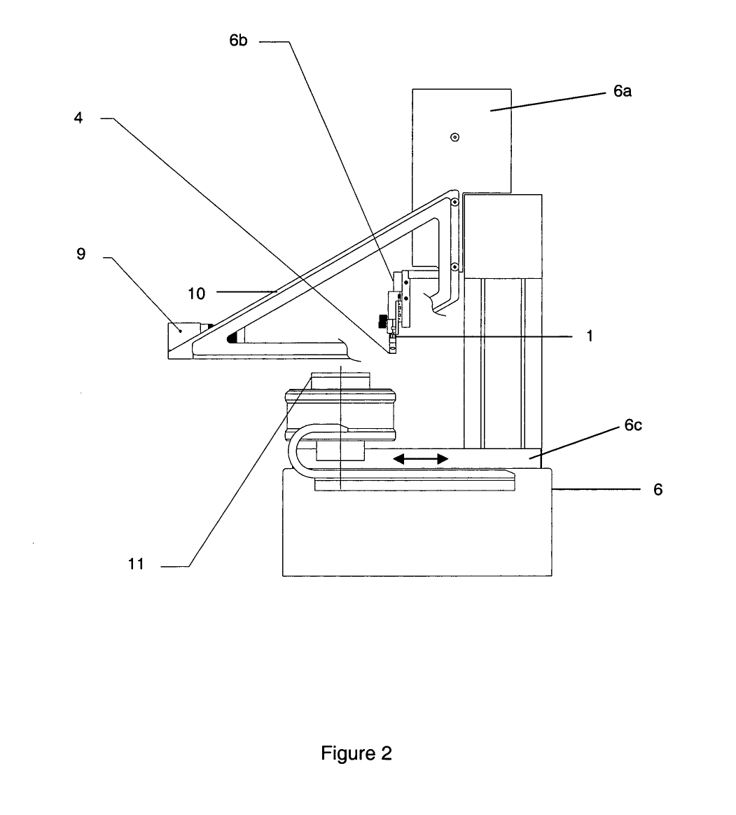

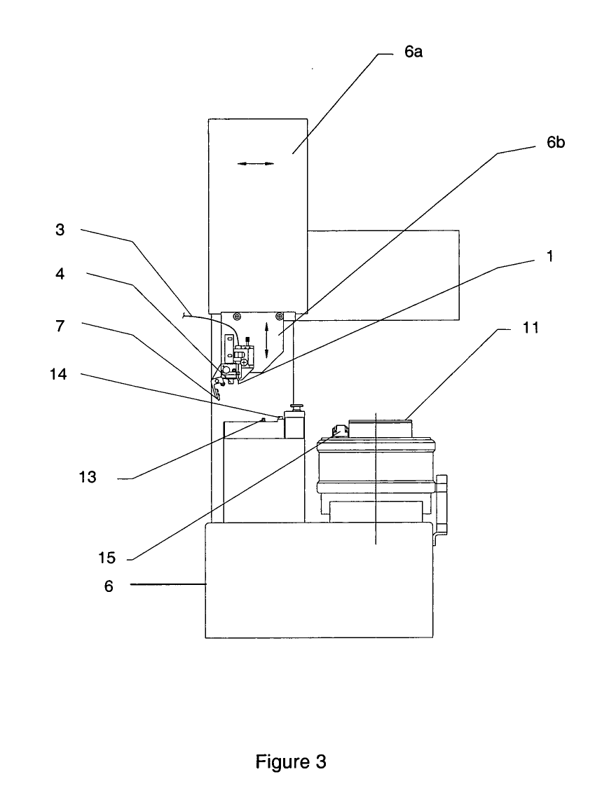

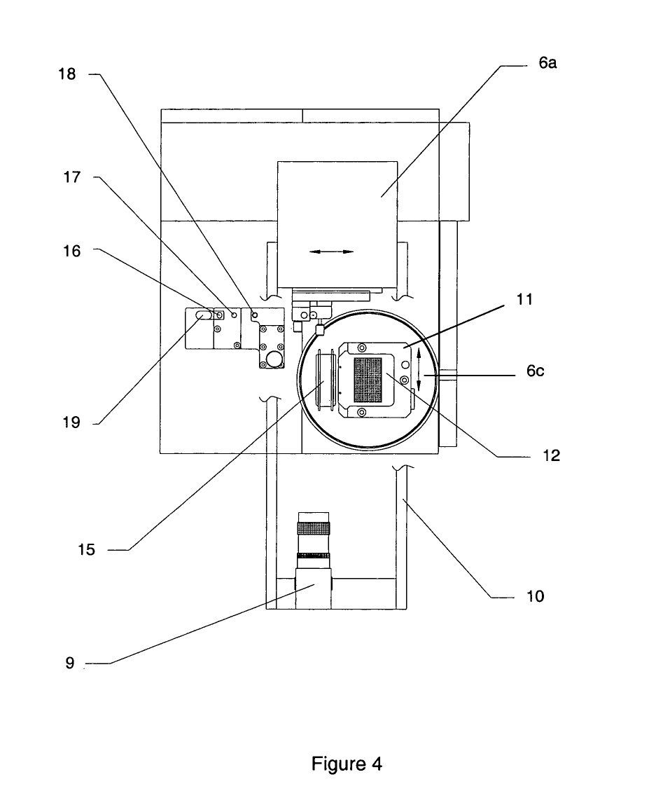

The apparatus and method of the invention will now be further illustrated by reference to the figures and following examples:

An apparatus according to the of the invention which is adapted to produce sample arrays on a substrate suitable for MALDI mass spectrometry, comprises capillary (1) held in a capillary housing (2) fed from the capillary feed line (3), which in turn is connected to a LC system (not shown). Preferably the exit of a chromatography column comprises a short capillary feed line (3) (for example but not limited to 30 mm or less), ensuring minimal sample mixing during passage through the capillary outlet. The very low internal volume provided by the short exit capillary ensures that the sharp separation of the eluted sample e.g. peptides is maintained.

The capillary (1) is adjacent to a matrix inkjet valve (4) held in a matrix valve housing (5). The capillary housing (2) and the matrix valve housing (5) being located on x and z transports of the translation mechanism (6a, 6b). The capillary housing is attached to said Janome translation mechanism such that it may be moved along the x- and z-dimensions. It is clear that dependent upon which type of translation mechanism is selected, the capillary can be translated in one, two or all three dimensions or can be static. Similarly, the substrate may be capable of being translated in one, two or all three dimensions or can be static. In the delivery device of the invention, the substrate is moveable along the y-axis.

The matrix valve housing (5) and capillary housing (2) are separate housings and as such work independently however, a combined matrix valve and capillary housing could be used. The capillary housing (2) is preferably located nearby to one or more matrix valves (4) as illustrated, but may be located at a distance from the matrix valves.

The matrix solution is applied as small droplets by the matrix valve (4). The matrix delivery is vertical but could be directed at an angle. The matrix may delivered into any sample spot at any desired time by movement of the matrix valve (4) towards the required spot. Depending on the spot size required, the matrix can be added by multiple droplets or in a continuous stream.

The matrix valve (4) can be capped with the matrix valve cap (7) when not in use for protection and to prevent drying and/or the matrix solution from crystallizing and blocking the valve.

During set-up of the apparatus the height of the capillary can be adjusted manually using the manual height adjustment knob (8).

A machine vision system camera (9), operably linked to the robot (6) is mounted on a bracket (10) giving a view of the matrix valve (4) adjacent to the capillary (1). The bracket (10) is attached to the translation mechanism transports (6a, 6b) such that movement of the camera (9) is synchronised with that of the capillary (1) and matrix valve (4). In an alternative embodiment this camera may be static. A substrate holder (11) adapted to retain a substrate (12) is positioned on y transport (6c) of the translation mechanism, which is a modified Janome JR 2200 mini desktop robot (6), such that it lies in the x, y plane of the translation mechanism. The substrate is provided with alignment features (13a-d) for the accurate placement of the whole array and individual sample spots (14).

A capillary drying station (15) is positioned horizontally on the desktop robot (6). Also provided are a matrix valve dry station (16), matrix valve wash station (17) and capillary wash station (18). A drain for liquid waste (19) is provided adjacent to the matrix valve dry station (16).

The apparatus of the invention is enclosed and also comprises a temperature control mechanism (PID) enabling control of sample and matrix spot drying.

The delivery device additionally comprises a machine vision system to observe and optionally control delivery of sample and matrix and a further machine vision system camera for quality control purposes (not shown).

In use, sample is supplied to the liquid delivery apparatus from an autosampler (Famos, LC Packings) and fed via a fused silica capillary to a hplc column. The chromatography column does not have to be mounted on the liquid delivery apparatus but it can be. It can be located elsewhere and the capillary feed line (3) taken to the head of the delivery device. A fused silica capillary outlet from the chromatography column may be used, and is preferably as short as possible. The liquid flow through the chromatography column can be continuous, unwanted liquid (column washes etc.) flowing to waste (19).

In use, defined boundary markers may be used in the delivery and control of a sample spot of liquid as follows:

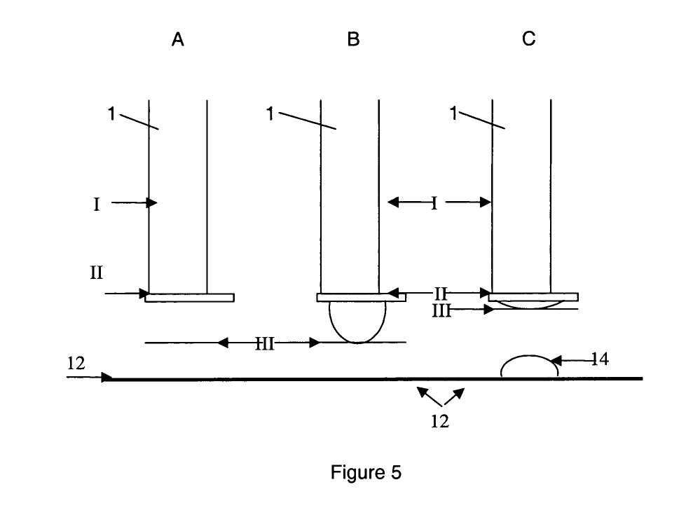

FIG. 5 illustrates one embodiment of the method. In FIG. 5A shows the capillary (1) of the liquid delivery apparatus in the absence of a forming drop in relation to boundary markers I and II (rectangle) relative to the substrate (12). FIG. 5, scene B shows partial drop formation from the capillary, when a pre-set size of the forming drop is achieved on reaching boundary marker II the machine vision system relays a signal to the liquid delivery apparatus to descend along the z-axis until said capillary is just above the substrate bringing the partial drop of liquid forming on the outlet of the capillary into contact with the substrate. The capillary is then retracted resulting in the deposition of a partial drop of liquid onto the substrate. The capillary housing returns to the initial boundary maker position shown as the rectangle II. FIG. 5, scene C shows the capillary of the liquid delivery apparatus after partial drop deposition but with a remaining undeposited volume; if required the volume can be calculated using the distance between known boundary marker III and boundary marker II and using the known flow rate from the capillary. This volume can be subtracted from the partial drop (14) volume to give the deposited drop volume shown on the substrate (12). The boundary markers are moveable features and are shown relative to the substrate (12).

The number of applications required for a pre-set volume to be delivered can be adjusted as necessary to accommodate the flow rate of the sample separation system. This partial drop application gives spot diameters that are approximately the same as the outside diameter of the capillary; the capillary diameter can be varied as required but is preferably 400 μm or less. Multiple applications of drops of sample, coupled with natural or controlled evaporation, enables the sample to be concentrated on the plate. Each drop of sample delivered onto the substrate is partially reduced in volume by controlled evaporation using a PID system before the next drop of sample is delivered. This gives true volume control, regardless of any change in viscosity of the sample during elution from a liquid chromatography (LC) system such as seen during gradient formation where organic solvents are typically employed for biomolecule elution. Monitoring and control of spot size successfully addresses the problem of increasing spot diameters caused by wetting of the substrate by organic solvents or other additives in the sample such as detergents. This is achieved by, for example but not by way of limitation, using retraction of the capillary to apply a drop of sample in a greater number of aliquots thereby maintaining the production of spots of the required diameter with reproducible accuracy. The means to compensate for such changes in sample composition facilitates the production of spots of reproducible diameter during the delivery of sample from, for example but not by way of limitation, an on-line LC system where the elution of peptides or other molecules from a chromatography column is achieved using a gradient of increasing organic solvent content. Preferably the LC separation is a step in the proteomics separations of peptides produced from samples differentially labelled with ICAT reagents.

Liquid matrix is delivered to a sample spot that is substantially reduced in volume yet still liquid whilst the size of the sample spot is optically monitored using an operably connected machine vision system that signals the delivery from a liquid delivery device to deliver matrix when the sample spot has reached a pre-determined size. Subsequent deliveries of matrix, as required, are added whilst the sample spot is still liquid but preferably after it has been reduced in size by evaporation, giving control of the matrix concentration within a spot.

Alternatively, the method of the invention can use pre-set timing to deposit partial drops of liquid onto a substrate.

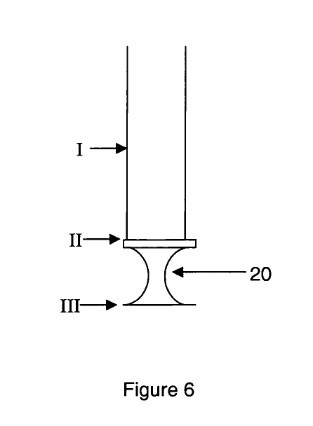

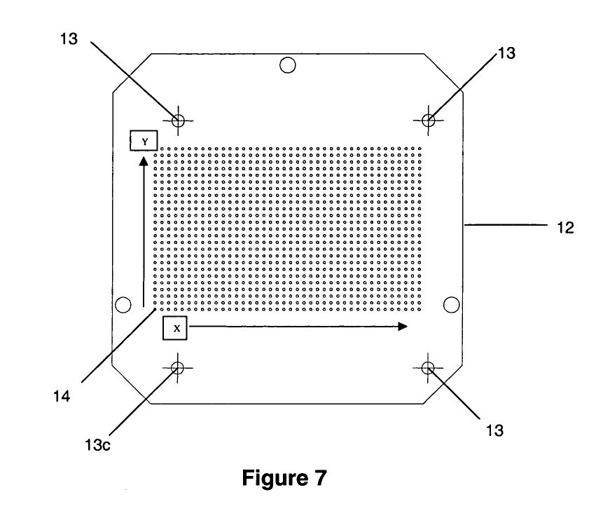

FIG. 6 illustrates a second embodiment of the method which utilises a machine vision system to measure the width of the spot, this comprises generating a partial drop as before and bringing together the capillary and substrate until the drop touches the substrate and forms a diabolo (or hourglass) shape (20) between the substrate and the capillary outlet. The capillary is held at this position until the diabolo-shape fills out to a cylinder or convex cylinder shape defined by boundary markers when the capillary is again retracted to regain the diabolo-shape (FIG. 6). The machine vision system uses defined boundary markers (I, II, III where boundary marker III is at the level of the substrate) to constantly monitor the distance between the capillary and the substrate to maintain a constant liquid contact whilst maintaining the preferred spot diameter. This diameter (which is preferably finally no greater than the diameter of the capillary) is maintained by constant automatic adjustment of the distance between the capillary and the substrate and also accommodates the flow rate of the sample from the capillary. The capillary moves to the next position of the array after a pre-determined time and hence volume or when a pre-determined spot diameter is achieved. This monitoring is important in compensating for changes in the evaporation rate of the drying sample due to increases in organic solvent concentrations during the LC gradient formation and for maintaining the required spot diameter which would typically increase with increasing organic solvent concentration as discussed above.

The following details are a particular example of operating the liquid delivery apparatus described above. It is understood that many permutations of delivery, applications and sample separation are possible:
a) The liquid delivery apparatus is started simultaneously with the LC system, using a pre-programmed delay to allow sample application, preferably onto a polished stainless steel substrate, to commence when the sample reaches the capillary tip. Alternatively, a system such as but without limitation, a UV or micro-flow rate detector can be used to initiate sample application. Prior to spotting, the capillary tip sits over the waste pot, allowing effluent to run to waste.
b) When ready to apply sample, the capillary housing moves to the wash station, performs a wash routine, and moves on to the drying station to remove the constantly forming drop from the end of the capillary.
c) Sample application commences as previously described. By way of example but not of limitation, after six sample spots have been applied, matrix is applied to sample spot one (before it has dried and whilst it is minimally liquid). After sample spot seven has been applied matrix is added to sample spot two and so on.
d) A sample is chromatographically separated using an operably connected LC system and delivered over, e.g. 25 spots, after which the chromatography column is re-equilibrated and the capillary washed ready for the next run. The delivery device for matrix solution is washed ready for the next run.

It is understood that matrix may be applied at any time to any spot of the array. Preferably, quality control monitoring of sample delivery and matrix addition is performed routinely. All critical system functions are monitored, and controlled so that they are “fail-safe” thus preserving the sample wherever possible in the event of a failure.

The LC system may comprise multiple separation columns with a switching valve, for continuous sample running (no equilibration wait time), permitting continuous delivery and application onto substrates.

Two examples of matrix delivery are as follows and are in no way meant to be limiting:
a) for 400 micron spots; 8000 Hz, 8 pulses, no delay, matrix valve 0.2 psi; and
   b) for 600 micron spots 1000 Hz, 2 pulses, no delay, matrix valve 0.2 psi.

Preferably, the matrix valve is flushed with air followed by methanol and then air once again before the addition of new matrix. The valve is then tested in manual flush and pulse modes and the matrix reservoir tested for leaks. Any suitable matrix solvent may be used. CHCA, and most preferably acetone containing TFA may be used as a matrix solvent. The following solvent formulations are given by way of example and not of limitation, and permit the reliable use of an inkjet or inkjet valve:
(i) 5 mg/ml CHCA, 0.1% TFA, in 50% ethanol in water,
(ii) 5 mg/ml CHCA, 0.1% TFA, in 50% propanol in water, and most preferably;
(iii) 5 mg/ml CHCA, 0.1% TFA, in 50% acetone in water.

The concentration of matrix solution is preferably between 1 and 10 mg/ml and most preferably 5 mg/ml. The concentration of solvent used is preferably between 10 and 100% and most preferably 50%.

### EXAMPLE

Peptides generated by tryptic digestion of a solution of Bovine serum albumin were arrayed on an unmodified stainless steel substrate suitable for mass spectrometry in a Perseptive Voyager (Applied Biosystems, Framingham, Mass.) in the following manner. The delivery device of the invention was enclosed in a cabinet with a temperature control system (PID) allowing the temperature to be maintained between 34° C. and 36° C.

The capillary of the liquid delivery device was supplied with a constant flow rate of 160 nl/min of a solution of 100 fmol/μl BSA peptides. The delivery device was set up to deliver eleven discrete partial drops of liquid into each position on the target substrate to form one sample spot (equivalent to approximately 10 fmol BSA peptides). Delivery of matrix was performed using “one spot back delivery”; i.e. liquid matrix was delivered from an ink-jet valve into the penultimate spot at a given time said spot being still liquid after each spot was delivered. The matrix was delivered vertically downwards into the liquid sample spot.

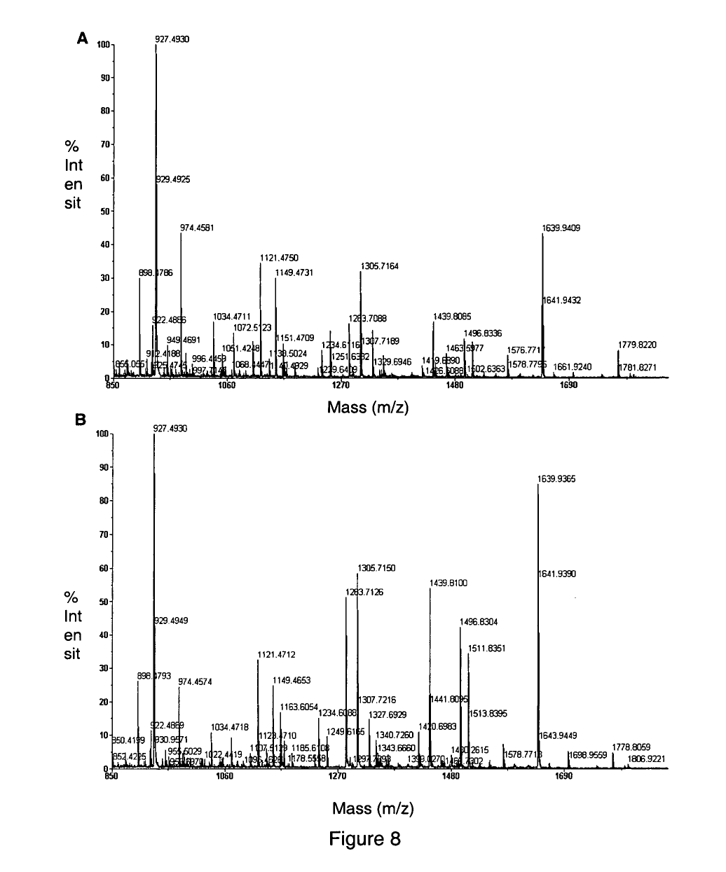

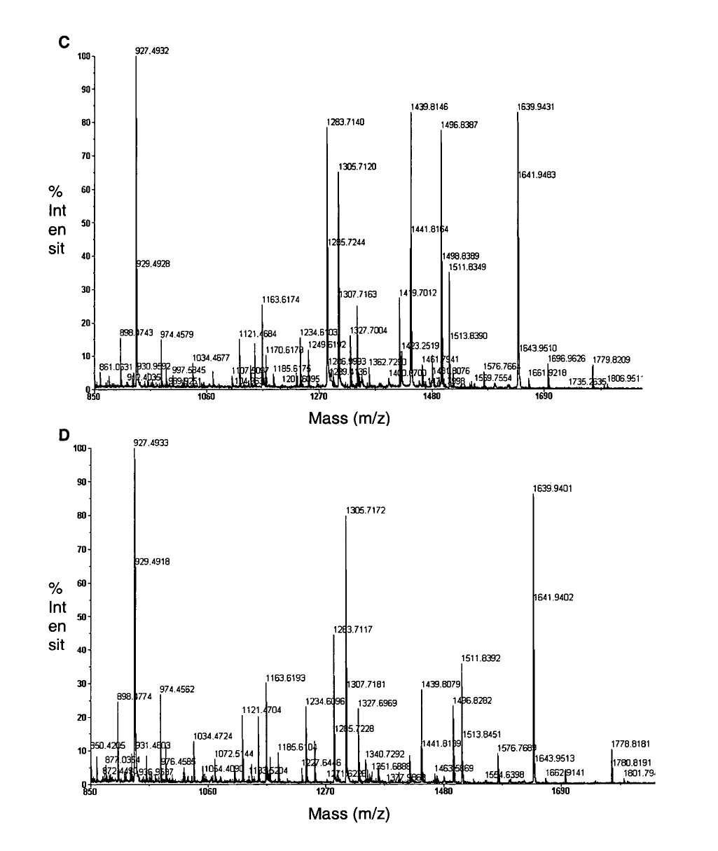

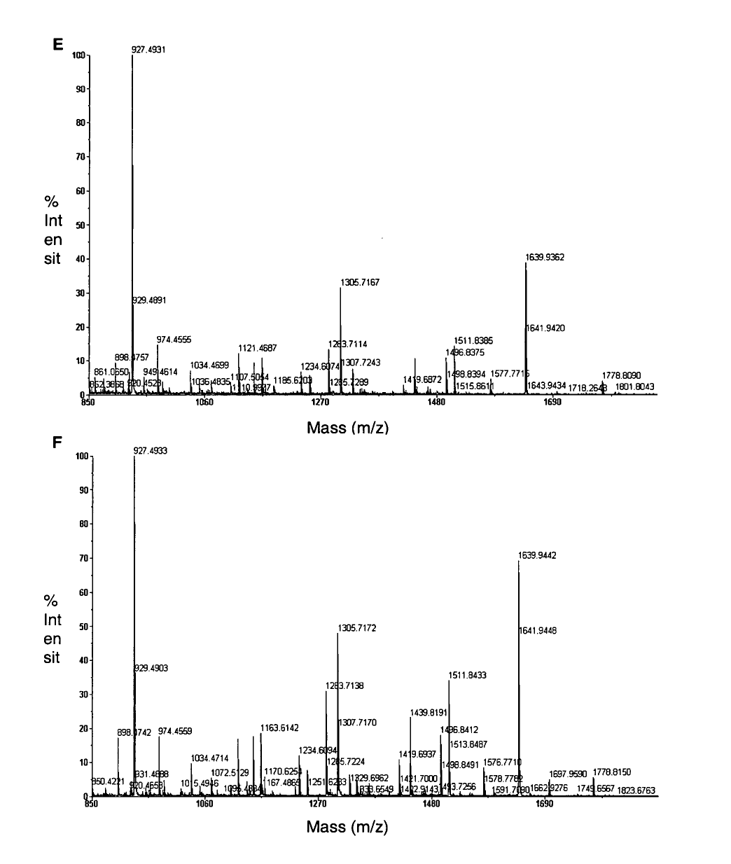

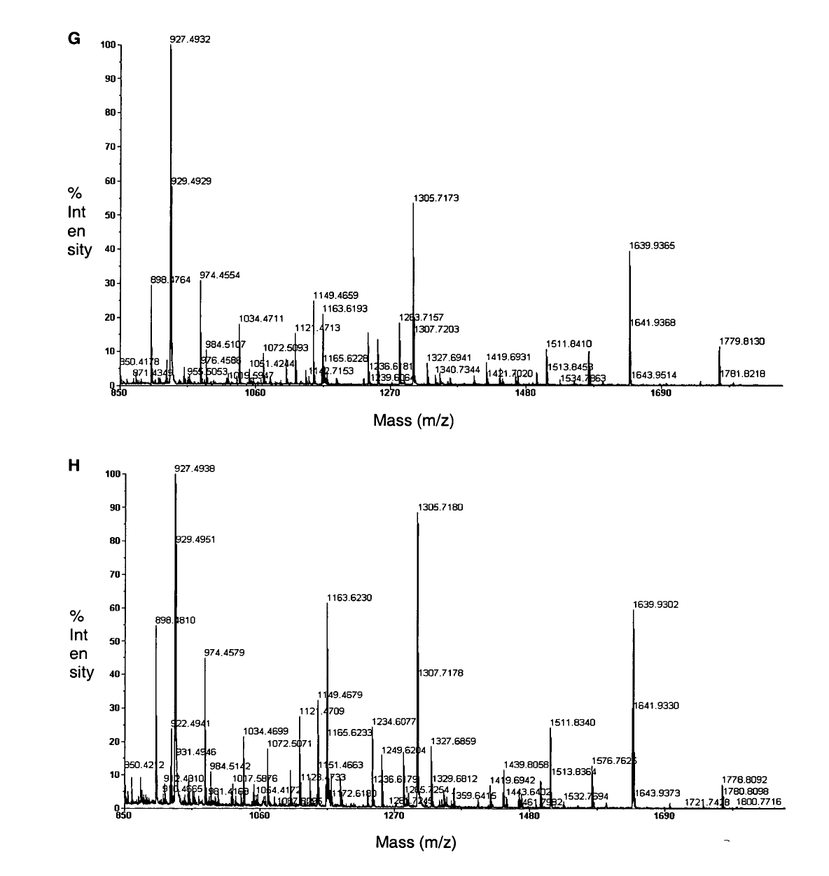

MALDI-MS was performed using 50 shots of the laser (intensity 2400, a repetition rate 3.1 Hz) in one arbitrary position within a sample spot; spectra from eight consecutive spots were collected (FIG. 8). In all eight compiled spectra the major ions visible are present in all spectra showing the consistency of the sample spots (for example ions of approximately: 1639.9, 15511.8, 1305.7, 1283.7, 1163.6, 974.4 and 927.4 Da). The most intense ion (˜927.4 Da) shows a mean intensity of 5.36×10⁴±a std, deviation of 0.8×10⁴.

1. A method for delivering a spot of liquid onto a substrate comprising:
(a) bringing a hollow capillary into contact with the liquid;
(b) locating the capillary above a selected position on the substrate;
(c) delivering a partial drop of liquid from the capillary onto the substrate by relative movement of the capillary and substrate;
(d) retraction of the capillary and substrate relative to each other; and
(e) repeating steps (c) and (d) one or more times.

2. The method of claim 1, wherein the delivery of sample is achieved by movement of the capillary towards the substrate followed by retraction of said capillary.

3. The method of claim 1 or 2, wherein a plurality of discrete partial drops of liquid are applied to the same position on the substrate.

4. The method of claim 3 wherein the spot of liquid on the substrate is partially dried between each deposition of a partial drop of liquid.

5. The method of claim 3 or 4, wherein the retraction of the capillary relative to the substrate is greater each time, to a degree dependent on the flow rate of the liquid through the capillary and the height of the spot of liquid on the substrate.

6. The method of claim 1 or 2, wherein said retraction of the capillary is such as to maintain the contact of the partial drop of liquid with both the capillary and the substrate, the relative movement of the capillary and substrate being controlled to maintain a column of liquid between the substrate and the capillary of a pre-determined width.

7. A liquid delivery apparatus comprising:
(a) at least one hollow capillary contactable with the liquid;
(b) a housing to retain said capillary in a desired orientation;
(c) one or more thermal, mechanical or electrical second liquid delivery devices;
(d) a housing to retain said second liquid delivery device in a desired orientation;
(d) a substrate holder; and
(e) a translation mechanism capable of performing x, y and z movements, said mechanism being capable of moving said capillary, second liquid delivery device and substrate holder relative to one another.

8. The liquid delivery apparatus of claim 7, further comprising a means of controlling the evaporation rate of the deposited drop of liquid.

9. The liquid delivery apparatus of claim 7 or 8, which comprises means to measure the volume of liquid deposited upon a substrate.

10. The apparatus or method according to any one of the preceding claims, wherein the diameter of each spot is less than 750 μm.

11. The apparatus or method according to any one of the preceding claims, wherein the diameter of each spot is between 100 μm and 500 μm.

12. The apparatus or method according to any one of the preceding claims, wherein the diameter of the partial drop formed on the end of the capillary is no greater than the diameter of the capillary.

13. The apparatus or method according to any one of the preceding claims, wherein the capillary is connected to the outlet of a sample separator.

14. The apparatus or method according to any one of the preceding claims, wherein the capillary is coated or surface treated with a non-wetting agent.

15. A method of application of a matrix material, suitable for MALDI mass spectrometry, in one or more aliquots to a plurality of sample spots, said spots being generated according to the method of any one of claims 1 to 6 and 10 to 14, comprising non-contact delivery of said matrix material from a second delivery device.

16. The method of claim 15, wherein the matrix material is delivered onto the sample spots before said spots have dried.

17. The method according to claim 15 or 16, wherein the second delivery device is washed and/or dried at least once during the generation of an array of sample spots

18. A method according to any one of claims 1 to 6 and 10 to 17, comprising using a computer comprising a computer-readable medium with program instructions, for generating machine-readable instructions that direct a liquid delivery apparatus according to any one of claims 7 to 9, to commence producing an array of spots of sample on a substrate.

19. A method according to any one of claims 1 to 6 and 10 to 18, comprising using a computer comprising a computer-readable medium having a program recorded thereon, where the program instructs the computer execute procedure to perform the following steps:
(a) generate instructions that direct a device comprising a sample separator to commence delivery of liquid;
(b) generate instructions that direct a liquid delivery apparatus according to any one of claims 7 to 9, to commence delivering a plurality of spots of said liquid, wherein the device of part (a) is interfaced to a capillary of the liquid delivery apparatus; and
(c) generate instructions that direct the liquid delivery apparatus of part (b) to deliver matrix material according to any one of claims 15 to 17.

20. A method according to any one of claims 1 to 6 and 10 to 19, wherein the liquid is derived from the separations of samples that have been labelled with undeuterated or D₈-isotope-coded affinity tags or alternatively with undeuterated or D₇-isotope labelled tags.

21. A method according to any one of claims 1 to 6 and 10 to 20 for the production of a plurality of spatially distinct spots of sample on a substrate for analysis.

22. The method according to claim 21, wherein the sample comprises peptides and the analysis comprises mass spectrometry.

23. A method for producing an array of peptides for mass spectrometric analysis on a solid substrate comprising:
(a) bringing a hollow capillary into contact with a liquid sample containing polypeptides;
(b) locating the capillary above a selected position on the substrate;
(c) delivering a partial drop of liquid from the capillary onto the substrate by relative movement of the capillary and substrate;
(d) retraction of the capillary and substrate relative to each other
(e) repeating steps (c) and (d) one or more times;
(f) relocating the capillary above a different selected position on the substrate and performing steps (c) to (e);
(g) repeating step (f) one or more times; and
(h) applying a matrix solution to the spots of liquid on the substrate before the liquid has completely evaporated.
